(19) United States
(12) Patent Application Publication
(10) Pub. No.: US 2023/0160720 A1
(43) Pub. Date: May 25, 2023

(54) ELECTRIC MILEAGE ESTIMATION DEVICE, ELECTRIC MILEAGE ESTIMATION METHOD, AND RECORDING MEDIUM

(71) Applicant: Panasonic Intellectual Property Management Co., Ltd., Osaka (JP)

(72) Inventors: Takuma IIDA, KANAGAWA KEN (JP); Masato WAGATSUMA, KANAGAWA KEN (JP); Iori UEDA, KANAGAWA KEN (JP)

(73) Assignee: Panasonic Intellectual Property Management Co., Ltd., Osaka (JP)

(21) Appl. No.: 18/100,839

(22) Filed: Jan. 24, 2023

Related U.S. Application Data
(63) Continuation of application No. PCT/JP2021/019245, filed on May 20, 2021.

(30) Foreign Application Priority Data
Jul. 31, 2020 (JP) 2020-131124

(51) Int. Cl. G01C 21/00

(52) U.S. Cl. CPC G01C 21/387; G01C 21/3889

(57) ABSTRACT

An electric mileage estimation device includes a hardware processor connected to a memory. The hardware processor calculates a first electric mileage estimation value on the basis of traveling condition information included in information about a traveling schedule. The hardware processor also calculates a second electric mileage estimation value on the basis of: information about traveling place information included in the information about the traveling schedule, and electric mileage map information in which map information is associated with an electric mileage corresponding to the map information. The hardware processor estimates an electric mileage on the basis of the first electric mileage estimation value and the second electric mileage estimation value. The hardware processor outputs information based on the electric mileage.

### CROSS-REFERENCE TO RELATED APPLICATIONS

This application is a continuation of International Application No. PCT/JP2021/019245, filed on May 20, 2021 which claims the benefit of priority of the prior Japanese Patent Application No. 2020-131124, filed on Jul. 31, 2020, the entire contents of which are incorporated herein by reference.

### FIELD

The present disclosure relates generally to an electric mileage estimation device, an electric mileage estimation method, and a recording medium.

### BACKGROUND

In recent years, there is disclosed a technique for estimating an electric mileage on a traveling route. The estimation is performed by, for example, using actual values of electric mileage, which are collected from a plurality of electric vehicles for each link that connects nodes virtually set (for example, JP P2019-086304A).

### SUMMARY

An electric mileage estimation device according to the present disclosure includes a hardware processor connected to a memory. The hardware processor is configured to calculate a first electric mileage estimation value on the basis of traveling condition information included in information about a traveling schedule. The hardware processor is configured to also calculate a second electric mileage estimation value on the basis of: information about traveling place information included in the information about the traveling schedule, and electric mileage map information in which map information is associated with an electric mileage corresponding to the map information. The hardware processor is configured to estimate an electric mileage on the basis of the first electric mileage estimation value and the second electric mileage estimation value. The hardware processor is configured to output information based on the electric mileage.

### BRIEF DESCRIPTION OF THE DRAWINGS

FIG. 1 is an overview configuration diagram of a delivery management system according to an embodiment;

FIG. 2 is a diagram for explaining a data structure of delivery data;

FIG. 3 is a diagram for explaining a data structure of measurement data;

FIG. 4 is a block diagram illustrating an example of a hardware configuration of a power consumption prediction system;

FIG. 5 is a functional block diagram of the power consumption prediction system;

FIG. 6 is a diagram for explaining a data structure of information stored in a traveling electric mileage information storage unit;

FIGS. 7A to 7D are diagrams for explaining a data structure of information stored in an electric mileage map information storage unit;

FIG. 8 is a flowchart illustrating a processing procedure for calculating a first electric mileage estimation value;

FIG. 9 is a flowchart illustrating a processing procedure for calculating a second electric mileage estimation value;

FIG. 10 is a flowchart illustrating a processing procedure for calculating an electric mileage estimation value; and

FIG. 11 is a flowchart illustrating a processing procedure for setting weighting.

### DETAILED DESCRIPTION

The following describes an embodiment of a delivery management system according to the present disclosure with reference to the drawings.

Schematic Configuration of Delivery Management System

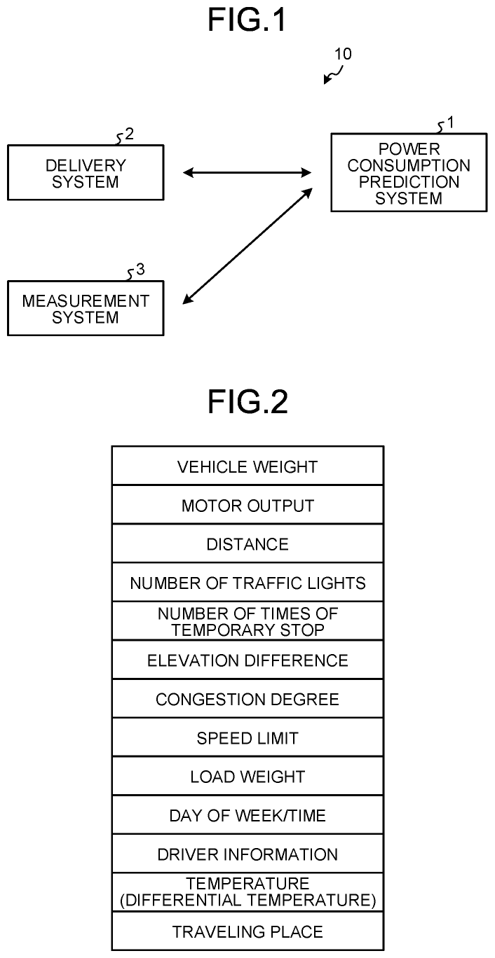

FIG. 1 is an overview configuration diagram of the delivery management system according to the embodiment. A delivery management system 10 includes a power consumption prediction system 1, a delivery system 2, and a measurement system 3. The power consumption prediction system 1 and the delivery system 2 are capable of transmitting/receiving information to/from each other over a network. The power consumption prediction system 1 and the measurement system 3 are also capable of transmitting/receiving information to/from each other over the network.

The delivery management system 10 is a system that manages a delivery state of an electric vehicle. The delivery management system 10 sets a delivery route for the electric vehicle, and calculates a power consumption of the electric vehicle in a case of traveling on the delivery route. The delivery management system 10 also manages a traveling history and an electric mileage of the electric vehicle to calculate the power consumption. The traveling history of the electric vehicle is a history related to a traveling condition and the like.

The power consumption prediction system 1 is an information processing device such as a server device. The power consumption prediction system lmay be implemented with a plurality of server devices that can perform processing in collaboration with each other via a network. The power consumption prediction system 1 acquires measurement data from the measurement system 3 and stores the measurement data. The measurement data described above is, for example, information including information about an electric mileage. When delivery data as information about delivery and a request for calculation of a power consumption are received from the delivery system 2, the power consumption prediction system 1 estimates an electric mileage on the basis of the delivery data and information stored in the power consumption prediction system 1 in advance. Then, the power consumption prediction system 1 calculates a power consumption based on the electric mileage and outputs the power consumption to the delivery system 2. In this manner, the power consumption prediction system 1 functions as an electric mileage estimation device.

The delivery system 2 is, for example, an information processing device such as a server device. The delivery system 2 searches for a delivery route by using map information including a link or a mesh, and generates information about a delivery plan. The delivery system 2 makes a request for calculation of the power consumption by transmitting, to the power consumption prediction system 1, the delivery data including information based on a delivery route search result as information about the delivery route, vehicle information as information about a traveling electric vehicle, and so forth. Upon acquiring information on the power consumption from the power consumption prediction system 1, the delivery system 2 determines a charging amount of the electric vehicle as a target on the basis of the acquired power consumption.

The map information described above may include information about a traveling speed limit of each road, information about a temporary stop point, and information about a traffic jam level for each time period. When generating the information on the delivery plan described above, the delivery system 2 may acquire information about the weather from an external device. The information about the weather is, for example, temperature information of each route. The delivery system 2 may acquire traffic jam information from an external device.

The following describes an example of the delivery data transmitted by the delivery system 2 with reference to FIG. 2. FIG. 2 is a diagram for explaining a data structure of the delivery data.

As illustrated in FIG. 2, the delivery data includes a vehicle weight, a motor output, a distance, the number of traffic lights, the number of times of temporary stop, an elevation difference, a congestion degree, a speed limit, a load weight, a day of a week/time, driver information, and information on a temperature. The vehicle weight, the motor output, the distance, the number of traffic lights, the number of times of temporary stop, the elevation difference, the congestion degree, the speed limit, the load weight, the day of the week/time, the driver information, and the information on a temperature are each information on the traveling condition. The information on the traveling condition may include a traveling time. The delivery data may further include information on a traveling place in addition to the information on the traveling condition described above.

Herein, the vehicle weight is a weight of the electric vehicle, which is information acquired from the vehicle information and the like. The motor output is a motor output of the electric vehicle, which is information acquired from the vehicle information and the like. The distance is a traveling distance of the delivery route, which is information based on the delivery route search result. The number of times of temporary stop indicates the number of temporary stop points on the delivery route, which is information based on the delivery route search result.

The elevation difference indicates an elevation difference on the delivery route, that is, for example, a difference between a traveling start point and a traveling end point. Alternatively, the elevation difference may be a difference between the highest point and the lowest point on the delivery route. The elevation difference may be an elevation difference at each link on the delivery route. The elevation difference is information based on the delivery route search result. The congestion degree is information indicating a congestion degree on the delivery route, for example, an average of a congestion level and the like on the delivery route. The congestion degree is information based on the delivery route search result. The speed limit is information about a speed limit set for a road in the delivery route, for example, an average speed of speed limits of roads in the delivery route. The speed limit is information based on the delivery route search result. As the information on the traveling condition, an average speed and average acceleration at each link on the delivery route may be added to the delivery data. The average speed may be an average speed excluding a stopping state.

The load weight is a weight of a load on the electric vehicle, which is information based on the vehicle information and the like. The day of the week/time indicates a day of the week/time when delivery is performed, which is information based on the delivery route search result. This information may include not only the day of the week/time but also a date and time. The driver information indicates roughness of driving performed by a driver of the electric vehicle, which is information based on attribute information and the like of the driver of the electric vehicle.

The temperature is information about a temperature during delivery, which is information based on weather information during delivery. The temperature may be a differential temperature as information based on a difference in temperatures. The delivery data described above may include information for identifying the delivery data. The information for identifying the delivery data is, for example, a delivery data ID. The delivery data may also include information other than the information described above. For example, the delivery data may include positional information on the delivery route. As the positional information on the delivery route described above, exemplified are positional information such as a start point, a through point, and a destination point.

The information on the traveling place is information about the traveling route, which is information on a link corresponding to the traveling route and a mesh corresponding to the traveling route. The information on the traveling place may also include information indicating a ratio of each link or each mesh on the traveling route to the entire traveling route. The information on the traveling place may also include information on a gradient at the link corresponding to the traveling route.

The measurement system 3 is, for example, an information processing device such as a server device. The measurement system 3 acquires measurement data including information about the electric mileage at the time of traveling from the electric vehicle, the delivery system 2, and the like, and transmits the measurement data to the power consumption prediction system 1.

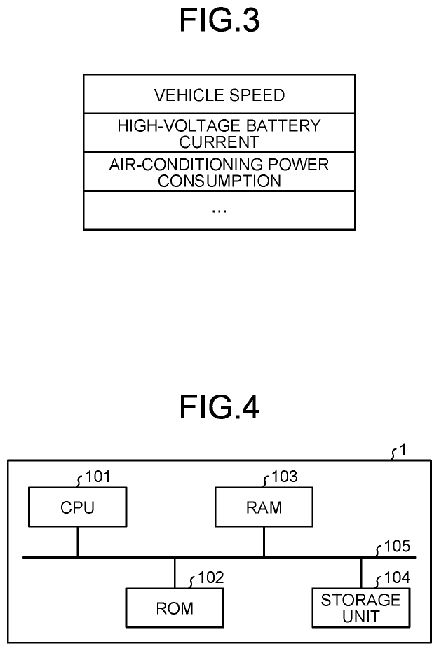

The following describes an example of the measurement data transmitted by the measurement system 3 with reference to FIG. 3. FIG. 3 is a diagram for explaining a data structure of the measurement data.

The measurement data is data including information for calculating the electric mileage. This information includes a vehicle speed, a high-voltage battery current, and an air-conditioning power consumption. The vehicle speed is information about a vehicle speed at the time when the vehicle travels along a search result of the delivery route. The high-voltage battery current is information about a high-voltage battery current as a result of traveling. The air-conditioning power consumption is information indicating an air-conditioning power consumption at the time of traveling. The measurement data may include information for calculating the electric mileage in addition to the information illustrated in FIG. 3. The measurement data may also include the delivery data ID. With this configuration, the delivery data can be associated with the measurement data. The measurement data may further include information included in the delivery data. This is because information at the time of searching for the delivery route may be different from information at the time of actual traveling. For example, a temperature at the time of searching for the delivery route may be different from a temperature at the time of actual traveling. The measurement data may also include information indicating a power consumption amount of traveling.

Moreover, the measurement data may include an electric mileage for each link or each mesh of the traveling place where the vehicle has actually traveled.

Hardware Configuration of Power Consumption Prediction System

Next, the following describes a hardware configuration of the power consumption prediction system 1. FIG. 4 is a block diagram illustrating an example of the hardware configuration of the power consumption prediction system 1. The power consumption prediction system 1 includes a central processing unit (CPU) 101, a read only memory (ROM) 102, a random access memory (RAM) 103, and a storage unit 104. The respective constituent elements are electrically connected to each other via a bus line 105.

The CPU 101 (an example of the hardware processor) controls an operation of the entire power consumption prediction system 1. The ROM 102 stores various computer programs. The RAM 103 temporarily stores various kinds of data and the like. The CPU 101 loads the computer program stored in the ROM 102 and the like into the RAM 103, and operates in accordance with the loaded computer program to control the power consumption prediction system 1.

The storage unit 104 stores various computer programs, data, and the like. In the present embodiment, for example, the storage unit 104 stores various kinds of information and the like. The storage unit 104 is, for example, a solid state drive (SSD), a hard disk drive (HDD), and the like, which hold storage information even when a power supply is turned off.

Functional Configuration of Power Consumption Prediction System

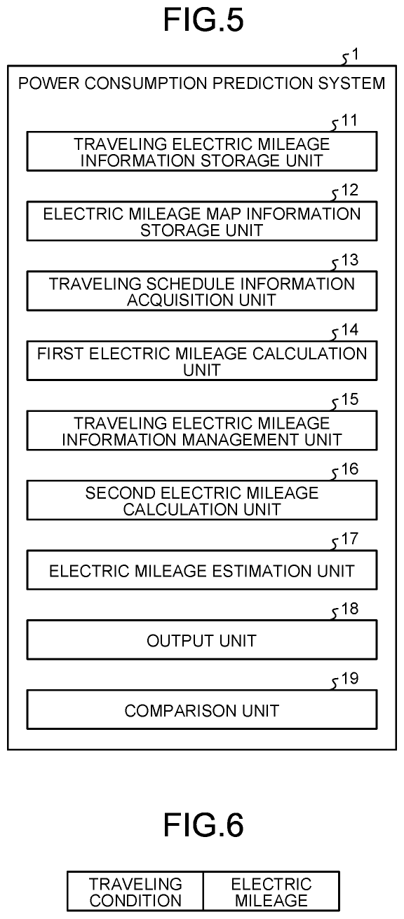

The following describes a function of the power consumption prediction system 1 with reference to FIG. 5. FIG. 5 is a functional block diagram of the power consumption prediction system 1. The power consumption prediction system 1 includes a traveling electric mileage information storage unit 11, an electric mileage map information storage unit 12, a traveling schedule information acquisition unit 13, a first electric mileage calculation unit 14, a traveling electric mileage information management unit 15, a second electric mileage calculation unit 16, an electric mileage estimation unit 17, an output unit 18, and a comparison unit 19.

The traveling electric mileage information storage unit 11 stores information in which traveling condition information as information about the traveling history is associated with the electric mileage of traveling. For example, the traveling electric mileage information storage unit 11 stores information in which the traveling condition information included in the delivery data described above is associated with the electric mileage calculated from the measurement data indicating a result of traveling along the delivery data.

The following describes a data structure of information stored in the traveling electric mileage information storage unit 11 with reference to FIG. 6. FIG. 6 is a diagram for explaining the data structure of the information stored in the traveling electric mileage information storage unit 11.

As illustrated in FIG. 6, the information stored in the traveling electric mileage information storage unit 11 is, as described above, information in which the traveling condition as the information about the traveling condition in the delivery data is associated with the information about the electric mileage calculated from the measurement data indicating a result of traveling along the delivery data. The information about the electric mileage includes an electric mileage, a power consumption amount, and the like. In a case where the measurement data further includes information included in the delivery data, the traveling condition information included in the delivery data may be associated with the electric mileage to be stored in the traveling electric mileage information storage unit 11 after calculating the electric mileage from the measurement data. The traveling electric mileage information storage unit 11 may further store different information. For example, in a case where the delivery data includes the positional information on the delivery route, the positional information on the delivery route may be stored in the traveling electric mileage information storage unit 11. The positional information on the delivery route described above is positional information such as a start point, a through point, and a destination point.

The traveling electric mileage information storage unit 11 may store stopping time power consumption amount information as information in which a stopping time as the traveling condition is associated with a power consumption amount as information about the electric mileage. The stopping means that the electric vehicle stops in a state where a high-voltage device is operating for a predetermined time. The stopping time power consumption amount information is, for example, information that is generated on the basis of a traveling result of the electric vehicle, which has been traveled in the past. The stopping time power consumption amount information indicates that the power consumption amount is typically increased as the stopping time is prolonged.

The traveling electric mileage information storage unit 11 may store average speed power consumption amount information as information in which the average speed as the traveling condition is associated with the power consumption amount as information about the electric mileage. Herein, the average speed is an average speed in a period during which the vehicle is not stopping. The average speed power consumption amount information is, for example, information that is generated on the basis of a traveling result of the electric vehicle, which has been traveled in the past. The power consumption amount in the average speed power consumption amount information may be a power consumption amount per unit time or unit distance.

Herein, it is assumed that the average speed is classified into a low speed region, a medium speed region, and a high speed region. The low speed region is a vehicle speed region in which power consumption efficiency tends to be deteriorated due to acceleration resistance. The high speed region is a vehicle speed region in which power consumption efficiency tends to be deteriorated due to influence of air resistance. The medium speed region is a region in which power consumption efficiency is favorable as compared with the low speed region and the high speed region.

The average speed power consumption amount information indicates that the power consumption amount is typically increased in a case where the average speed falls within the low speed region or the high speed region.

Returning to FIG. 5, the electric mileage map information storage unit 12 is configured to store electric mileage map information in which the map information is associated with the electric mileage corresponding to the map information. The electric mileage map information storage unit 12 may also store information based on information on the electric mileage for each link or each mesh of the traveling place where the vehicle has actually traveled included in the measurement data described above.

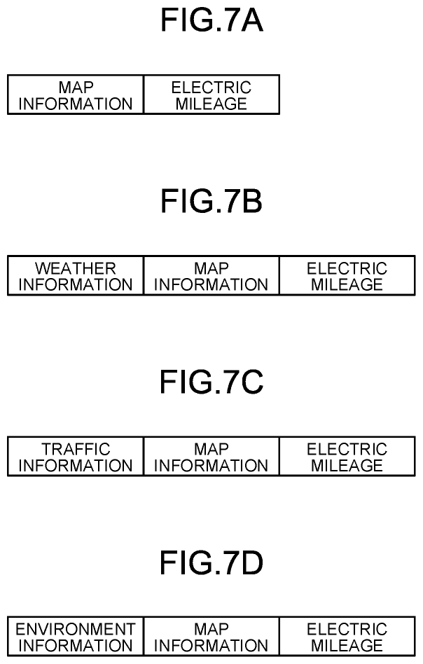

The following describes a data structure of the electric mileage map information stored in the electric mileage map information storage unit 12 with reference to FIGS. 7A to 7D. FIGS. 7A to 7D are diagrams for explaining the data structure of the information stored in the electric mileage map information storage unit 12. For example, as illustrated in FIG. 7A, the electric mileage map information storage unit 12 includes the map information and the information on the electric mileage. Herein, the map information indicates a link or a mesh. The electric mileage is expressed by a value based on an electric mileage at the time of traveling at a place of corresponding map information. Specifically, the electric mileage is, for example, an average value of the electric mileage at the time of traveling at the place of the corresponding map information. In this manner, the electric mileage map information storage unit 12 stores the information indicating the electric mileage for each link or each mesh.

The electric mileage map information stored in the electric mileage map information storage unit 12 may be further associated with information about the traveling condition. For example, as illustrated in FIG. 7B, the electric mileage map information may be further associated with weather information such as the weather and a temperature. As illustrated in FIG. 7C, the electric mileage map information may be further associated with traffic information such as a congestion degree. As illustrated in FIG. 7D, the electric mileage map information may be further associated with environment information indicating a time period such as nighttime. By using the electric mileage map information associated with the information on the traveling condition to estimate the electric mileage, the power consumption prediction system 1 is able to estimate the electric mileage more appropriately.

The electric mileage map information stored in the electric mileage map information storage unit 12 may be further associated with information about a plurality of traveling conditions. For example, the electric mileage map information may be further associated with weather information, traffic information, and environment information. The electric mileage map information storage unit 12 may further associate the electric mileage map information with information indicating the number of pieces of data from which the electric mileage is obtained corresponding to each piece of the map information. With this configuration, when information in which a certain piece of the map information is associated with the electric mileage is acquired, the power consumption prediction system 1 can appropriately calculate an average value of the electric mileage and update the electric mileage map information. For example, in a case where the measurement data acquired from the measurement system 3 includes the electric mileage for each link or each mesh of the traveling place where the vehicle has actually traveled, the power consumption prediction system 1 may use this information to update the information in the electric mileage map information storage unit 12.

Returning to FIG. 5, the traveling schedule information acquisition unit 13 is configured to acquire the delivery data. The delivery data corresponds to information about a traveling schedule. The traveling schedule information acquisition unit 13 acquires the delivery data from the delivery system 2 and receives the request for calculating the power consumption. After acquiring the delivery data, the traveling schedule information acquisition unit 13 sends out the delivery data to the first electric mileage calculation unit 14 and the second electric mileage calculation unit 16.

The first electric mileage calculation unit 14 calculates a first electric mileage estimation value on the basis of the traveling condition information included in the delivery data.

A method for calculating the electric mileage estimation value by the first electric mileage calculation unit 14 includes: a method for calculating the electric mileage estimation value on the basis of a traveling speed and acceleration at each link where the vehicle is scheduled to travel included in the delivery data, and a method for calculating the electric mileage estimation value by using the information stored in the traveling electric mileage information storage unit 11.

First, the following describes the method for calculating the first electric mileage estimation value on the basis of a traveling speed and acceleration at each link where the vehicle is scheduled to travel. Information on a gradient at each link and an elevation difference at each link may be further introduced. The first electric mileage calculation unit 14 calculates a power consumption amount on the basis of the following expression (1) or expression (2).

P₁=k₁+k₂×|α+g×sinθ|×V+k₃×(V³+a₁×V²+a₂×V) (1)

P₂=k₁−β×k₂×|α+g×sinθ|×V+k₃×(V³+a₁×V²+a₂×V) (2)

A coefficient k1 is a variable based on an energy consumption amount at the time of stopping and the time of traveling including the time of acceleration and deceleration. A coefficient k2 and a coefficient k3 are variables based on an energy consumption amount at the time of traveling including the time of acceleration and deceleration. These coefficient k1 to the coefficient k3 are calculated by using a multiple regression analysis method, a regression analysis method, and the like on the basis of an actually measured energy consumption amount in a target section by using a known technique.

V is a speed. A coefficient a1 and a coefficient a2 are constants that are set in accordance with a vehicle status and the like. α is acceleration, and θ is a road gradient. g is gravity acceleration. β is a recovery rate as a recovered amount of position energy and kinetic energy. The recovery rate of the electric vehicle is typically about 0.7 to 0.9.

The expression (1) described above is an expression for calculating an estimated energy consumption amount per unit time at the time of acceleration and the time of traveling. The expression (2) described above is an expression for calculating the estimated energy consumption amount per unit time at the time of deceleration. By inputting a traveling speed and traveling acceleration per unit time to the expression (1) and the expression (2) described above, energy consumption at the time of the traveling speed and the traveling acceleration can be estimated. However, when the power consumption amount is calculated by using a traveling speed and traveling acceleration per time unit such as every one second for the entire route, a calculation amount becomes extensive.

Considering the above, the first electric mileage calculation unit 14 uses an average value of the traveling speed and an average value of the traveling acceleration in a unified section such as a section per link to estimate the power consumption amount in this section on the basis of the expression (1) or the expression (2) described above. More specifically, the first electric mileage calculation unit 14 estimates the power consumption amount by using a demonstrative expression for a power consumption amount in the section indicated by an expression (3) or an expression (4) described later, or both of these expressions.

An estimation expression for a power consumption amount indicated by the expression (3) is an estimation expression for a power consumption amount in a section in a case where an altitude difference Δh in the section in which the electric vehicle travels is positive. In a case where the altitude difference Δh is positive is a case where the electric vehicle is traveling on an upward slope.

$$P = \frac{{P}_{1} + {P}_{2}}{2} = {k}_{1} + ( 1 - β ) \times \frac{{k}_{2}}{2} \times \vert \overline{α} \vert \times \overline{V} + {k}_{2} \times g \times Δ h + {k}_{3} ( {\overline{V}}^{3} + {a}_{1} \times {\overline{V}}^{2} + {a}_{2} \times \overline{V} ) \qquad ( 3 )$$

On the other hand, an estimation expression for a power consumption amount indicated by the expression (4) is an estimation expression for a power consumption amount in the section in a case where the altitude difference Δh in the section in which the electric vehicle travels is negative. The case where the altitude difference Δh is negative is a case where the electric vehicle is traveling on a downward slope.

$$P = \frac{{P}_{1} + {P}_{2}}{2} = {k}_{1} + ( 1 - β ) \times \frac{{k}_{2}}{2} \times \vert \overline{α} \vert \times \overline{V} + β \times {k}_{2} \times g \times Δ h + {k}_{3} ( {\overline{V}}^{3} + {a}_{1} \times {\overline{V}}^{2} + {a}_{2} \times \overline{V} ) \qquad ( 4 )$$

In the expression (3) and the expression (4) described above, the first term on the right side is an energy consumption amount consumed by an accessory mounted on the electric vehicle, for example, an energy consumption amount in an idling state. The second term on the right side is an energy consumption amount due to acceleration resistance. The third term on the right side is an energy consumption amount consumed as position energy. The fourth term on the right side is an energy consumption amount due to air resistance and rolling resistance given per unit area.

The first electric mileage calculation unit 14 calculates a power consumption amount for each link using the expression (3) and the expression (4) described above, and adds up calculated power consumption amounts for respective links to calculate an estimation value of the power consumption amount of the delivery route. The first electric mileage calculation unit 14 then calculates, on the basis of the estimation value of the power consumption amount of the delivery route and the traveling distance of the delivery route, the electric mileage estimation value using the calculation method on the basis of the traveling speed and the acceleration at each link where the vehicle is scheduled to travel.

In this manner, the first electric mileage calculation unit 14 calculates the electric mileage estimation value on the basis of the traveling speed and the acceleration at each link where the vehicle is scheduled to travel as the information on the traveling condition.

Subsequently, the following describes the method for calculating the electric mileage estimation value using the information stored in the traveling electric mileage information storage unit 11. The first electric mileage calculation unit 14 calculates a stopping time on the basis of the number of traffic lights, the number of times of temporary stop, and the congestion degree in the delivery data. The first electric mileage calculation unit 14 makes reference to the stopping time power consumption amount information in the traveling electric mileage information storage unit 11 corresponding to the stopping time to specify the power consumption amount during the stopping time. The first electric mileage calculation unit 14 estimates the power consumption amount for the entire traveling route on the basis of the power consumption amount during the stopping time. For example, the first electric mileage calculation unit 14 makes reference to the average speed power consumption amount information in the traveling electric mileage information storage unit 11, and acquires a power consumption amount corresponding to the average speed excluding the stopping state.

The first electric mileage calculation unit 14 then calculates the power consumption amount at the time of traveling on the basis of the traveling time or the traveling distance, and the acquired power consumption amount. The first electric mileage calculation unit 14 adds the power consumption amount corresponding to the stopping time to the power consumption amount at the time of traveling to calculate the estimation value of the power consumption amount of the delivery route. The first electric mileage calculation unit 14 then calculates, on the basis of the estimation value of the power consumption amount of the delivery route and the traveling distance of the delivery route, the electric mileage estimation value using the method for calculating the electric mileage using the information stored in the traveling electric mileage information storage unit 11. In this manner, the first electric mileage calculation unit 14 calculates the electric mileage estimation value on the basis of the stopping time and the traveling time derived from the information on the traveling condition in the delivery data.

The first electric mileage calculation unit 14 may cause the electric mileage estimation value that is obtained by using the calculation method based on the traveling speed and the acceleration at each link where the vehicle is scheduled to travel described above to be the first electric mileage estimation value. The first electric mileage calculation unit 14 may also cause the electric mileage estimation value obtained by using the method for calculating the electric mileage using the information stored in the traveling electric mileage information storage unit 11 to be the first electric mileage estimation value. Alternatively, the first electric mileage calculation unit 14 may calculate the first electric mileage estimation value on the basis of respective electric mileage estimation values obtained by using the two methods described above. For example, the first electric mileage calculation unit 14 may cause an average value of the respective electric mileage estimation values obtained by using the two methods to be the first electric mileage estimation value.

The first electric mileage calculation unit 14 calculates the first electric mileage estimation value, and sends out the first electric mileage estimation value to the electric mileage estimation unit 17. The first electric mileage calculation unit 14 sends out the delivery data to the traveling electric mileage information management unit 15 and the comparison unit 19.

Procedure of First Electric Mileage Estimation Value Calculation Processing

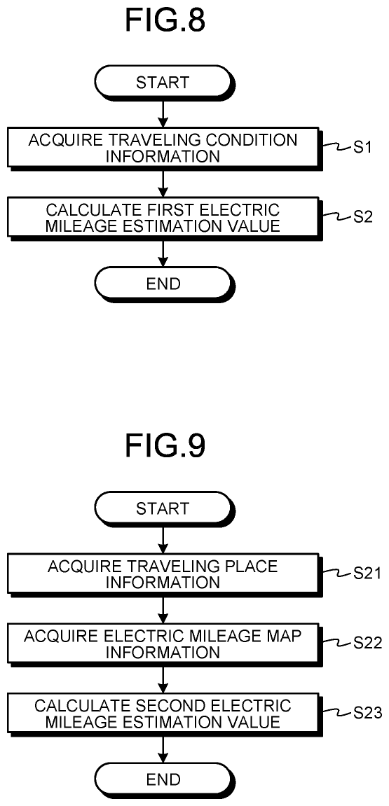

Subsequently, the following describes a processing procedure for calculating the first electric mileage estimation value with reference to FIG. 8. FIG. 8 is a flowchart illustrating the processing procedure for calculating the first electric mileage estimation value.

The traveling schedule information acquisition unit 13 acquires delivery data as the traveling schedule information from the delivery system 2 and receives a request for calculation of the power consumption. The first electric mileage calculation unit 14 acquires the delivery data including the traveling condition information from the traveling schedule information acquisition unit 13 (Step S1). Subsequently, the first electric mileage calculation unit 14 calculates the first electric mileage estimation value by the calculation method based on the traveling speed and the acceleration at each link where the vehicle is scheduled to travel, or the method for calculating the electric mileage using the information stored in the traveling electric mileage information storage unit 11 (Step S2).

Returning to FIG. 5, the traveling electric mileage information management unit 15 is configured to acquire additional information in which the traveling condition information is associated with the electric mileage. In addition, the traveling electric mileage information management unit 15 is configured to cause the traveling electric mileage information storage unit 11 to store the additional information.

The traveling electric mileage information management unit 15 acquires the delivery data from the first electric mileage calculation unit 14. The traveling electric mileage information management unit 15 also acquires the measurement data corresponding to the delivery data described above from the measurement system 3. The measurement data corresponding to the delivery data described above is measurement data the delivery data ID of which is identical to the delivery data ID of the delivery data. The traveling electric mileage information management unit 15 calculates the electric mileage of an actual traveling result from the information included in the measurement data. The traveling electric mileage information management unit 15 registers information in which the traveling condition information in the delivery data described above is associated with the electric mileage in the traveling electric mileage information storage unit 11.

For example, in a case where the positional information on the delivery route included in the delivery data acquired by the traveling schedule information acquisition unit 13 is often largely different from the positional information on the delivery route of the information in the traveling electric mileage information storage unit 11, the traveling electric mileage information management unit 15 may make a setting to remove, from a parameter calculation target, the information in the traveling electric mileage information storage unit 11 corresponding to the positional information that is largely different from the positional information on the delivery route included in the delivery data acquired by the traveling schedule information acquisition unit 13 by deleting this information, or moving this information to another storage region, for example. The positional information on the delivery route described above is, for example, positional information on a destination.

Returning to FIG. 5, the second electric mileage calculation unit 16 is configured to calculate the second electric mileage estimation value on the basis of: information on the traveling place information included in the information about the traveling schedule acquired by the traveling schedule information acquisition unit 13, and the electric mileage map information stored in the electric mileage map information storage unit 12. Upon acquiring the delivery data from the traveling schedule information acquisition unit 13, the second electric mileage calculation unit 16 calculates the second electric mileage estimation value on the basis of the traveling place information in the delivery data and the electric mileage map information stored in the electric mileage map information storage unit 12.

Specifically, upon acquiring the delivery data, the second electric mileage calculation unit 16 makes reference to the electric mileage map information storage unit 12 and acquires the electric mileage map information corresponding to each link or mesh included in the traveling place information in the delivery data. The second electric mileage calculation unit 16 then calculates, as the second electric mileage estimation value, an average value of electric mileages in the acquired electric mileage map information. In a case where the traveling place information in the delivery data includes a ratio of links and meshes to the entire traveling route, the second electric mileage calculation unit 16 may calculate the second electric mileage estimation value on the basis of the ratio and the electric mileages in the acquired electric mileage map information described above.

In a case where, as illustrated in FIG. 7B, the information about the traveling condition is associated with the electric mileage map information stored in the electric mileage map information storage unit 12, the second electric mileage calculation unit 16 may acquire the electric mileage map information corresponding to the traveling place and the traveling condition information in the delivery data. In the method for calculating the electric mileage by the second electric mileage calculation unit 16, the average value of the electric mileages in the electric mileage map information is used in the present embodiment, but the electric mileage map information may be limited on the basis of the traveling condition in the delivery data to calculate the second electric mileage estimation value.

The second electric mileage calculation unit 16 calculates the second electric mileage estimation value, and sends out the second electric mileage estimation value to the electric mileage estimation unit 17. The second electric mileage calculation unit 16 may send out, to the electric mileage estimation unit 17, the number of pieces of data from which the electric mileages in the acquired electric mileage map information are obtained.

Procedure of Second Electric Mileage Estimation Value Calculation Processing

Subsequently, the following describes a processing procedure for calculating the second electric mileage estimation value with reference to FIG. 9. FIG. 9 is a flowchart illustrating the processing procedure for calculating the second electric mileage estimation value. It is assumed that the power consumption prediction system 1 has caused the electric mileage map information storage unit 12 to store the electric mileage map information on the basis of the information acquired from the delivery system 2, the measurement system 3, and so forth.

First, the second electric mileage calculation unit 16 acquires the delivery data including the traveling place information from the traveling schedule information acquisition unit 13 (Step S21).

Subsequently, the second electric mileage calculation unit 16 makes reference to the electric mileage map information storage unit 12 and acquires the electric mileage map information corresponding to each link or mesh included in the traveling place information in the delivery data (Step S22). The second electric mileage calculation unit 16 then calculates, as the second electric mileage estimation value, an average value of electric mileages in the acquired electric mileage map information (Step S23).

Returning to FIG. 5, the electric mileage estimation unit 17 is configured to estimate the electric mileage on the basis of the first electric mileage estimation value calculated by the first electric mileage calculation unit 14 and the second electric mileage estimation value calculated by the second electric mileage calculation unit 16. Specifically, the electric mileage estimation unit 17 weights each of the first electric mileage estimation value calculated by the first electric mileage calculation unit 14 and the second electric mileage estimation value calculated by the second electric mileage calculation unit 16 to estimate the electric mileage.

The electric mileage estimation unit 17 acquires the first electric mileage estimation value from the first electric mileage calculation unit 14. Additionally, the electric mileage estimation unit 17 acquires, from the second electric mileage calculation unit 16, the second electric mileage estimation value and the number of pieces of data from which the electric mileages in the electric mileage map information corresponding to the traveling place are obtained.

The electric mileage estimation unit 17 determines whether there is sufficient number of pieces of data from which the respective electric mileages in the electric mileage map information corresponding to the traveling place are obtained. The sufficient number described above means that the number exceeds a predetermined threshold indicating a sufficient number, for example. In a case of determining that the number of pieces of data is sufficient, the electric mileage estimation unit 17 estimates, to be the electric mileage, a value that is weighted such that the second electric mileage estimation value is heavier than the first electric mileage estimation value. For example, the electric mileage estimation unit 17 estimates, to be the electric mileage, a value that is obtained by adding a value obtained by multiplying the first electric mileage estimation value by 0.2 to a value obtained by multiplying the second electric mileage estimation value by 0.8. Alternatively, the electric mileage estimation unit 17 may estimate, to be the electric mileage, a value that is obtained by adding a value obtained by multiplying the first electric mileage estimation value by 0.0 to a value obtained by multiplying the second electric mileage estimation value by 1.0, or may estimate, to be the electric mileage, a value that is obtained by adding a value obtained by multiplying the first electric mileage estimation value by 1.0 to a value obtained by multiplying the second electric mileage estimation value by 0.0. In other words, the electric mileage estimation unit 17 may estimate the electric mileage using only the first electric mileage estimation value, or may estimate the electric mileage using only the second electric mileage estimation value.

In a case where the number of pieces of data from which the respective electric mileages in the electric mileage map information corresponding to the traveling place are obtained is not sufficient, the electric mileage estimation unit 17 estimates, to be the electric mileage, a value that is weighted such that the first electric mileage estimation value is heavier than the second electric mileage estimation value. For example, the electric mileage estimation unit 17 estimates, to be the electric mileage, a value that is obtained by adding a value obtained by multiplying the first electric mileage estimation value by 0.8 to a value obtained by multiplying the second electric mileage estimation value by 0.2.

In this manner, the electric mileage estimation unit 17 weights each of the first electric mileage estimation value calculated by the first electric mileage calculation unit 14 and the second electric mileage estimation value calculated by the second electric mileage calculation unit 16 on the basis of a data amount of the electric mileage map information such as the number of pieces of data from which the electric mileages in the electric mileage map information corresponding to the traveling place are obtained.

Alternatively, the electric mileage estimation unit 17 may weight each of the first electric mileage estimation value and the second electric mileage estimation value on the basis of the number of pieces of the electric mileage map information stored in the electric mileage map information storage unit 12, instead of the number of pieces of data from which the electric mileages in the electric mileage map information corresponding to the traveling place are obtained.

In a case where there are little number of pieces of data from which the respective electric mileages in the electric mileage map information corresponding to the traveling place are obtained, the electric mileage estimation unit 17 may estimate the first electric mileage estimation value to be the electric mileage. The case described above in which there are little number of pieces of data from which the respective electric mileages in the electric mileage map information corresponding to the traveling place are obtained is, for example, a case where the number of pieces of data is smaller than a threshold indicating a minimum that is smaller than the threshold indicating the sufficient number described above.

The electric mileage estimation unit 17 may weight each of the first electric mileage estimation value and the second electric mileage estimation value on the basis of a comparison result obtained by the comparison unit 19 described later.

After estimating the electric mileage, the electric mileage estimation unit 17 calculates a power consumption value on the basis of the estimated electric mileage and the distance in the delivery data, and sends out the power consumption value to the output unit 18.

The output unit 18 outputs information based on the electric mileage estimated by the electric mileage estimation unit 17. Specifically, upon acquiring the power consumption value as the information based on the electric mileage from the electric mileage estimation unit 17, the output unit 18 transmits the power consumption value to the delivery system 2. The output unit 18 may acquire, from the electric mileage estimation unit 17, an electric mileage value itself estimated by the electric mileage estimation unit 17 and transmit the electric mileage value to the delivery system 2.

Procedure of Electric Mileage Estimation Processing

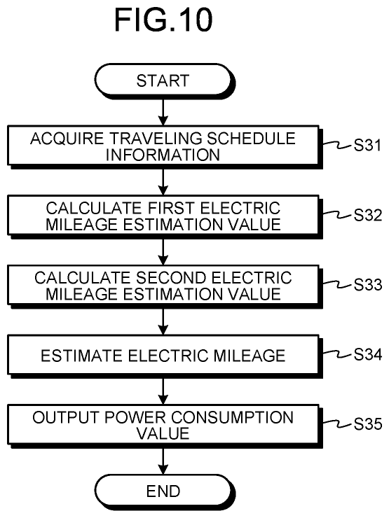

Subsequently, the following describes a processing procedure for calculating the electric mileage estimation value with reference to FIG. 10. FIG. 10 is a flowchart illustrating the processing procedure for calculating the electric mileage estimation value.

The traveling schedule information acquisition unit 13 acquires the delivery data as the traveling schedule information from the delivery system 2 and receives the request for calculating the power consumption (Step S31).

Subsequently, the first electric mileage calculation unit 14 calculates the first electric mileage estimation value on the basis of the traveling condition information in the delivery data, the information stored in the traveling electric mileage information storage unit 11, and the like (Step S32).

Subsequently, the second electric mileage calculation unit 16 calculates the second electric mileage estimation value on the basis of: the information about the traveling place information in the information about the traveling schedule acquired by the traveling schedule information acquisition unit 13, and the electric mileage map information stored in the electric mileage map information storage unit 12 (Step S33).

Subsequently, the electric mileage estimation unit 17 estimates the electric mileage on the basis of the first electric mileage estimation value calculated by the first electric mileage calculation unit 14 and the second electric mileage estimation value calculated by the second electric mileage calculation unit 16, and calculates the power consumption value based on the electric mileage (Step S34). The output unit 18 transmits the power consumption value to the delivery system 2 (Step S35).

Returning to FIG. 5, the comparison unit 19 is configured to acquire traveling result information in which the traveling condition information, the traveling place information, and a traveling result electric mileage are associated with each other. The comparison unit 19 is further configured to compare first information and second information. The first information is based on the traveling result electric mileage and a first electric mileage estimation value for comparison that is calculated on the basis of the traveling condition information included in the traveling result information. The second information is based on the traveling result electric mileage and a second electric mileage estimation value for comparison that is calculated on the basis of the electric mileage map information and the traveling place information in the traveling result information.

The comparison unit 19 acquires the delivery data including the traveling condition information and the traveling place information from the first electric mileage calculation unit 14. The comparison unit 19 also acquires the measurement data corresponding to the delivery data described above from the measurement system 3. Alternatively, the comparison unit 19 may acquire the measurement data via the traveling electric mileage information management unit 15. The comparison unit 19 calculates the electric mileage of an actual traveling result from the information included in the measurement data. As a result, the comparison unit 19 acquires the traveling result information that is information in which the traveling condition information, the traveling place information, and the electric mileage are associated with each other.

The comparison unit 19 holds the traveling result information until the number of pieces of the traveling result information described above reaches a given number. The certain number is, for example, 100. At a stage when the given number of pieces of the traveling result information is prepared, the comparison unit 19 calculates the first electric mileage estimation value for comparison on the basis of the traveling condition information in the traveling result information. Specifically, the comparison unit 19 uses the traveling condition information in the traveling result information to calculate the first electric mileage estimation value for comparison by using the method for calculating the first electric mileage estimation value by the first electric mileage calculation unit 14.

The comparison unit 19 calculates a correlation coefficient based on the first electric mileage estimation value for comparison and the electric mileage in the traveling result information. The comparison unit 19 also calculates information indicating accuracy of the first electric mileage estimation value for comparison as a result of comparing the first electric mileage estimation value for comparison with the electric mileage in the traveling result information. Herein, the information indicating the accuracy of the first electric mileage estimation value for comparison is information about the accuracy of the first electric mileage estimation value for comparison based on a result of comparing the first electric mileage estimation value for comparison with the electric mileage in the traveling result information.

Subsequently, the comparison unit 19 makes reference to the electric mileage map information storage unit 12 to acquire the electric mileage map information corresponding to the traveling place information in the traveling result information, and calculates the second electric mileage estimation value for comparison on the basis of the acquired electric mileage map information. The comparison unit 19 calculates a correlation coefficient that is based on the second electric mileage estimation value for comparison and the electric mileage in the traveling result information. The comparison unit 19 also calculates information indicating accuracy of the second electric mileage estimation value for comparison as a result of comparing the second electric mileage estimation value for comparison with the electric mileage in the traveling result information.

The comparison unit 19 determines weighting by comparing the correlation coefficient based on the first electric mileage estimation value for comparison and the information indicating the accuracy of the first electric mileage estimation value for comparison with the correlation coefficient based on the second electric mileage estimation value for comparison and the information indicating the accuracy of the second electric mileage estimation value for comparison. For example, in a case where a difference value between the correlation coefficient based on the second electric mileage estimation value for comparison and the correlation coefficient based on the first electric mileage estimation value for comparison exceeds a predetermined threshold, and the accuracy of the second electric mileage estimation value for comparison is larger, the comparison unit 19 sets a value for weighting such that the second electric mileage estimation value is heavier than the first electric mileage estimation value. In this manner, in a case where the accuracy of the second electric mileage estimation value can be estimated to be higher, the comparison unit 19 sets each value for weighting such that the second electric mileage estimation value is heavier than the first electric mileage estimation value.

In the example described above, described is a case where the comparison unit 19 determines weighting by using the correlation coefficients and the accuracy based on the first electric mileage estimation value for comparison and the second electric mileage estimation value for comparison. However, the weighting described above may be determined on the basis of only the correlation coefficients based on the first electric mileage estimation value for comparison and the second electric mileage estimation value for comparison. The comparison unit 19 may also determine the weighting described above on the basis of only the accuracy based on the first electric mileage estimation value for comparison and the second electric mileage estimation value for comparison.

After setting the value for weighting, the comparison unit 19 outputs the setting result to the electric mileage estimation unit 17. The electric mileage estimation unit 17 weights each of the first electric mileage estimation value and the second electric mileage estimation value to estimate the electric mileage on the basis of the setting result based on the comparison result.

Procedure of Weighting Setting Processing

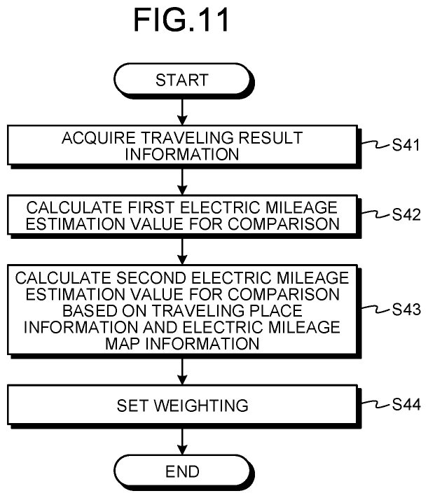

Subsequently, the following describes a processing procedure for setting weighting with reference to FIG. 11. FIG. 11 is a flowchart illustrating the processing procedure for setting weighting.

First, the comparison unit 19 acquires the delivery data and the measurement data corresponding to the delivery data, and acquires the traveling result information by calculating the electric mileage on the basis of the measurement data, and temporarily holds the traveling result information (Step S41). The comparison unit 19 calculates the first electric mileage estimation value for comparison using the traveling condition information in the traveling result information. The comparison unit 19 also calculates the correlation coefficient and the accuracy based on the first electric mileage estimation value for comparison (Step S42).

The comparison unit 19 also calculates the second electric mileage estimation value for comparison based on the traveling place in the traveling result information and the electric mileage map information. The comparison unit 19 also calculates the correlation coefficient and the accuracy based on the second electric mileage estimation value for comparison (Step S43).

The comparison unit 19 sets weighting on the basis of the correlation coefficient and the accuracy based on the first electric mileage estimation value for comparison and the correlation coefficient and the accuracy based on the second electric mileage estimation value for comparison (Step S44).

As described above, in the power consumption prediction system 1, the first electric mileage calculation unit 14 calculates the first electric mileage estimation value on the basis of the traveling condition information in the delivery data. The second electric mileage calculation unit 16 calculates the second electric mileage estimation value on the basis of: the information about the traveling place information in the information about the traveling schedule acquired by the traveling schedule information acquisition unit 13, and the electric mileage map information stored in the electric mileage map information storage unit 12. The electric mileage estimation unit 17 then estimates the electric mileage on the basis of the first electric mileage estimation value calculated by the first electric mileage calculation unit 14 and the second electric mileage estimation value calculated by the second electric mileage calculation unit 16, and calculates the power consumption value that is based on the electric mileage. The output unit 18 transmits the power consumption value to the delivery system 2.

In this manner, the power consumption prediction system 1 estimates the electric mileage using not only the electric mileage estimation method performed by the second electric mileage calculation unit 16 using the information in which the map information is associated with the electric mileage but also the electric mileage estimation method performed by the first electric mileage calculation unit 14 based on the traveling condition information. Therefore, the electric mileage can be appropriately estimated even in a case where there is no sufficient data in which the map information is associated with the electric mileage.

In a case where, as a result of comparing the correlation coefficient and the accuracy based on the first electric mileage estimation value for comparison with the correlation coefficient and the accuracy based on the second electric mileage estimation value for comparison, a difference between the correlation coefficient and the accuracy based on the first electric mileage estimation value for comparison and the correlation coefficient and the accuracy based on the second electric mileage estimation value for comparison is significant, the comparison unit 19 may perform weighting such that only one of the electric mileage estimation methods is used. That is, in accordance with the comparison result obtained by the comparison unit 19, the power consumption prediction system 1 may be switched to estimate the electric mileage using only the electric mileage estimation value obtained by using one of the electric mileage estimation methods including the electric mileage estimation method performed by the first electric mileage calculation unit 14 and the electric mileage estimation method performed by the second electric mileage calculation unit 16.

The computer program executed by the power consumption prediction system 1 according to the present embodiment is recorded and provided in a computer-readable recording medium such as an optical recording medium such as a digital versatile disc (DVD), a USB memory, a semiconductor memory device such as a solid state disk (SSD), and the like as an installable or executable file.

The computer program executed by the power consumption prediction system 1 according to the present embodiment may be stored in a computer connected to a network such as the Internet, and provided by being downloaded via the network. The computer program executed by the power consumption prediction system 1 according to the present embodiment may be provided or distributed via a network such as the Internet.

The computer program of the power consumption prediction system 1 according to the present embodiment may be embedded and provided in a ROM, for example.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The advantages of the embodiment described herein are merely examples, and not limited thereto. Other advantages may be exhibited.

What is claimed is:

1. An electric mileage estimation device comprising:
a hardware processor connected to a memory, the hardware processor being configured to:
calculate a first electric mileage estimation value on the basis of traveling condition information included in information about a traveling schedule;
calculate a second electric mileage estimation value on the basis of
information about traveling place information included in the information about the traveling schedule, and
electric mileage map information in which map information is associated with an electric mileage corresponding to the map information;
estimate an electric mileage on the basis of the first electric mileage estimation value and the second electric mileage estimation value; and
output information based on the electric mileage.

2. The electric mileage estimation device according to claim 1, wherein the hardware processor is configured to estimate the electric mileage by weighting each of the first electric mileage estimation value and the second electric mileage estimation value.

3. The electric mileage estimation device according to claim 2, wherein the hardware processor is configured to perform the weighting on each of the first electric mileage estimation value and the second electric mileage estimation value on the basis of a data amount of the electric mileage map information.

4. The electric mileage estimation device according to claim 2, wherein the hardware processor is configured to:
acquire traveling result information in which traveling condition information, traveling place information, and a traveling result electric mileage are associated with each other;
compare first information and second information, the first information being based on the traveling result electric mileage and a first electric mileage estimation value for comparison that is calculated on the basis of the traveling condition information included in the traveling result information, the second information being based on the traveling result electric mileage and a second electric mileage estimation value for comparison that is calculated on the basis of the traveling place information included in the traveling result information and the electric mileage map information; and
perform the weighting on each of the first electric mileage estimation value and the second electric mileage estimation value on the basis of a result of the comparison between the first information and the second information.

5. The electric mileage estimation device according to claim 4, wherein the hardware processor is configured to compare a correlation coefficient or accuracy of the first electric mileage estimation value for comparison and a correlation coefficient or accuracy of the second electric mileage estimation value for comparison.

6. The electric mileage estimation device according to claim 1, wherein, in the electric mileage map information, information about a traveling condition is further associated.

7. The electric mileage estimation device according to claim 1, wherein the map information included in the electric mileage map information includes information about a link or a mesh.

8. An electric mileage estimation method implemented by a computer, the method comprising:
calculating a first electric mileage estimation value on the basis of traveling condition information included in information about a traveling schedule;
calculating a second electric mileage estimation value on the basis of
information about traveling place information included in the information about the traveling schedule, and
electric mileage map information in which map information is associated with an electric mileage corresponding to the map information;
estimating an electric mileage on the basis of the first electric mileage estimation value and the second electric mileage estimation value; and
outputting information based on the electric mileage.

9. A non-transitory computer-readable recording medium on which programmed instructions are recorded, the instructions causing a computer to execute processing, the processing comprising:
calculating a first electric mileage estimation value on the basis of traveling condition information included in information about a traveling schedule;
calculating a second electric mileage estimation value on the basis of
information about traveling place information included in the information about the traveling schedule, and
electric mileage map information in which map information is associated with an electric mileage corresponding to the map information;
estimating an electric mileage on the basis of the first electric mileage estimation value and the second electric mileage estimation value; and
outputting information based on the electric mileage.
